(19) United States
(12) Patent Application Publication
(10) Pub. No.: US 2017/0073856 A1
(43) Pub. Date: Mar. 16, 2017

(54) FABRIC FOR MAKING AIRBAGS AND METHOD OF MAKING SAME

(71) Applicant: INVISTA NORTH AMERICA S.A.R.L., Wilmington, DE (US)

(72) Inventors: Janet H MYERS, Kingston (CA); Varunesh SHARMA, Johns Creek, GA (US); Martin TOWNSON, Gloucestershire (GB); Robert V WALSH, Atlanta, GA (US)

(21) Appl. No.: 15/121,158

(22) PCT Filed: Feb. 26, 2015
(86) PCT No.: PCT/US2015/017646

§ 371 Date: Aug. 24, 2016

Related U.S. Application Data
(60) Provisional application No. 61/944,899, filed on Feb. 26, 2014.

(51) Int. Cl. D03D 1/02; B60R 21/235; D03D 15/00

(52) U.S. Cl. CPC D03D 1/02; D03D 15/00; B60R 21/235; D10B 2321/0211; D10B 2331/04; D10B 2505/124; B60R 2021/23509

(57) ABSTRACT

A woven fabric comprising a base yarn and a secondary yarn, wherein the secondary yarn is interwoven into the base yarn, and wherein the secondary yarn has a melting point that is lower than the melting point of base yarn. Also disclosed is a method of making a base yarn and a secondary yarn, wherein the secondary yarn is interwoven into the base yarn, and wherein the secondary yarn has a melting point that is lower than the melting point of base yarn.

### RELATED APPLICATION

This application claims priority to U.S. Provisional Application No. 61/944,899, filed on Feb. 26, 2014.

### FIELD OF THE INVENTION

The invention relates to woven fabrics formed from multi-polymer based yarns that can be used to produce airbags.

### BACKGROUND OF THE INVENTION

Inflatable airbags are of key component of vehicle safety systems. As used herein, “air bag” means inflatable passive safety restraints for automobiles and many other forms of transportation, including military and aviation applications. Air bags are one form of inflatable passive safety restraint device which are now standard in automotive use. In recent years, the number of airbags and area of coverage for these airbags has increased. Multiple air bag configurations in use include air bags for the front seating area, for side impact protection, for rear seat use, for use in headliner area inflatable curtains, and for use in inflatable seat belts.

To meet the requirements for effective inflation, airbag fabric must have controlled low air permeability. While fabric properties, such as the linear density of the yarns, twist factors, weave construction and thickness and weight, all influence air permeability, it has usually been necessary to add a coating or additional layer to airbag fabrics to meet industry standards.

To meet the requirements for effective inflation, airbag fabric must have the ability to resist the passage of air, which is tested by air permeability and porosity. Therefore, it is desirable for woven nylon or polyester airbags to have a very low porosity and correspondingly low air permeability. While fabric properties, such as the linear density of the yarns, twist factors, weave construction and thickness and weight, all influence air permeability, it has usually been necessary to add a coating or additional layer to airbag fabrics to meet industry standards.

Polyester and polyamide fabrics having various coatings to reduce permeability are known. U.S. Pat. No. 5,897,929 describes a polyester or polyamide fabric coated with a porosity blocking layer of polyamide material. U.S. Pat. No. 5,110,666 describes a fabric substrate which is often coated with a polycarbonate-polyether polyurethane which provides certain permeability, flexibility, toughness, thermal resistance and other properties. U.S. Pat. No. 5,076,975 describes a molding operation for forming an elastomer-coated fabric having a defined shape. U.S. Pat. No. 5,763,330 describes a method for extrusion coating a polyethylene resin onto a nylon fabric.

The woven fabrics from which air bags are traditionally manufactured may also be coated with elastic materials (notably silicone rubber) to manage the air permeability of the fabric. Furthermore, the coating process is a slow and laborious process which increases the cost of airbag cushion fabrics and typical silicone elastomers used in coating are also expensive. As a result, alternatives to coatings have been sought over the past few years. However, these alternatives involve further process steps and more complexity. In addition, no alternate technology has been commercially successful and has not achieved the optimal performance of all of the critical performance parameters needed in airbag cushion application.

Therefore, there is a need in the art for an airbag fabric that does not require a coating and can still meet critical performance standards, such as low air permeability and porosity.

### SUMMARY OF THE INVENTION

The present invention relates to a woven fabric comprising multiple polymer yarns and methods for production and use of such fabric.

Accordingly, in one aspect of the present invention, relates to a woven fabric comprising a base yarn and a secondary yarn, wherein the secondary yarn is interwoven into the base yarn, and wherein the secondary yarn has a melting point that is lower than the melting point of base yarn.

In one nonlimiting embodiment, the woven fabric contains interstices and at least a portion of the secondary yarn has been melted such that the interstices between the base yarn are bridged by the melted portion of the secondary yarn.

In another nonlimiting embodiment, the fabric has a base weight in the range from 80 to 450 grams per square meter.

In another nonlimiting embodiment, the secondary yarn is present in the fabric in a range from 10 to 40 weight percent.

In another nonlimiting embodiment, the base yarn is formed from a polyamide fiber. In another nonlimiting embodiment, the base yarn formed from a polyester fiber.

In another nonlimiting embodiment, the secondary yarn has a linear mass density in the range from 20 to 800 decitex.

In another nonlimiting embodiment, the secondary yarn is formed from a polyolefin fiber. In another nonlimiting embodiment, the secondary yarn is formed from a high density polyethylene fiber.

In another nonlimiting embodiment, the woven fabric has an air permeability that is at least 50% lower than the air permeability of the woven fabric prior to at least a portion of the secondary yarn being melted such that interstices between the base yarn are bridged by the melted portion of the secondary yarn.

In another nonlimiting embodiment, the woven fabric has an air permeability that is at least 75% lower than the air permeability of the woven fabric prior to at least a portion of the secondary yarn being melted such that interstices between the base yarn are bridged by the melted portion of the secondary yarn.

In another nonlimiting embodiment an airbag is disclosed comprising the woven fabric from various embodiments of the present invention.

In another aspect of the present invention a fused fabric is disclosed comprising a woven fabric comprising a base yarn, wherein the base yarn contains interstices and a filling material which at least partially fills the interstices in the base yarn.

Another aspect of the present invention relates to process for making a treated fabric. The process comprises the steps of interweaving a base yarn with a secondary yarn to form a woven fabric, wherein the secondary yarn has a melting point that is lower than the melting point of base yarn and heating the woven fabric to a temperature above the melting point of the secondary yarn and below the melting point of the base yarn, wherein at least a portion of the secondary yarn melts to fowl a treated fabric. In another nonlimiting embodiment, a treated fabric formed from this process is disclosed. In another nonlimiting embodiment, an airbag formed from the treated fabric of this process is disclosed.

### BRIEF DESCRIPTION OF THE DRAWINGS

The accompanying drawings illustrate exemplary embodiments of the present disclosure, and together with the general description given above and the detailed description given below, serve to explain, by way of example, principles of the present disclosure.

FIG. 1 is a graph depicting the relationship between the amount of HDPE in a fabric and its thermal resistance.

FIG. 2 is a fabric design in accordance with the present disclosure.

FIG. 3 is an image, obtained via Scanning Electron Microscopy, of a fabric design in accordance with the present disclosure.

FIG. 4A is another image of a fabric design in accordance with the present disclosure, wherein the secondary yarn is shown as melted and present on one side of the fabric.

FIG. 4B is another image of a fabric design in accordance with the present disclosure, wherein the base yarn is shown as being woven and present on one side of the fabric.

### DETAILED DESCRIPTION OF THE INVENTION

In certain embodiments, the present invention relates to a treated woven fabric and method for making the same, wherein the fabric is formed from a base yarn of and at least one secondary yarn. The resultant fabric exhibits reduced air permeability and porosity when compared to woven fabrics made only from the base fabric or a woven fabric formed from the base fabric and the at least one secondary yarn.

All patents, patent applications, test procedures, priority documents, articles, publications, manuals, and other documents cited herein are fully incorporated by reference to the extent such disclosure is not inconsistent with this invention and for all jurisdictions in which such incorporation is permitted.

A woven fabric of the present invention comprises a base yarn. The base yarn may be present in a range resulting in 60 to 99.9% by weight of the woven fabric. In certain embodiments, the base yarn may be present, for example, in an amount ranging from 60 to 99.5%, from 60 to 99%, from 60 to 95%, from 60 to 90%, from 60 to 85%, from 60 to 80%, from 60 to 75%, from 65 to 99.9%, from 65 to 99.5%, from 65 to 99%, from 65 to 95%, from 65 to 90%, from 65 to 85%, from 65 to 80%, from 70 to 99.9%, from 70 to 99.5%, from 70 to 99%, from 70 to 95%, from 70 to 90%, from 70 to 85%, from 70 to 80%, from 75 to 99.9%, from 75 to 99.5%, from 75 to 99%, from 75 to 95%, from 75 to 90%, from 80 to 99.9%, from 80 to 99.5%, from 80 to 99%, and from 80 to 95%, all based on the weight of the woven fabric. The base yarn may be selected from any suitable synthetic yarn. Examples of suitable synthetic yarns that may be used for the base yarn include yarns formed from polyamide or polyester fibers.

Suitable polyamide fibers have a linear mass density in the range from 100 to 950 decitex, such as from 200 to 900 deeitex, from 250 to 850 decitex, from 300 to 850 decitex, from 350 to 850 decitex, from 400 to 850 decitex, from 400 to 800 decitex and from 450 to 800 decitex. Suitable polyamide fibers include those formed from nylon 6,6, nylon 6, nylon 6,12, nylon 12, nylon 4,6 or copolymers or blends thereof. In one nonlimiting embodiment of the present invention, the base yarn is formed from a nylon 6,6 fiber.

Suitable polyester fibers have a linear mass density in the range of 200 to 950 decitex, such as from 300 to 900 decitex, from 300 to 850 decitex, from 350 to 850 decitex, from 400 to 850 decitex, from 400 to 800 decitex, from 450 to 800 decitex, and from 500 to 800 decitex. Suitable polyester fibers include those formed from polyethylene terephthalate (PET), polybutylene terephthalate, polyethylene naphthalate, polybutylene naphthalate, polyethylene-1,2-bis(phenoxy)ethane-4,4′-dicarboxylate, poly(1,4cyclohexylene-dimethylene terephthalate and copolymers comprising at least one type of recurring units of the above-mentioned polymers, for example, polyethylene terephthalate/isophthalate copolyesters, polybutylene terephthalate/naphthalate copolyesters, polybutylene terephthalate/decanedicarboxylate copolyesters, or copolymers or blends thereof. In one nonlimiting embodiment of the present invention, the base yarn is formed from a PET fiber.

The woven fabric of the present invention further comprises a secondary yarn that may be present in a range resulting in 0.1 to 40% by weight of the woven fabric. In certain embodiments, the secondary yarn may be present, for example, in an amount ranging from 0.1 to 35%, from 0.1 to 30%, from 0.1 to 25%, from 0.1 to 20%, from 0.5 to 40%, from 0.5 to 35%, from 0.5 to 30%, from 0.5 to 25%, from 0.5 to 20%, from I to 40%, from 1 to 35%, from 1 to 30%, from 1 to 25%, from 1 to 20%, from 5 to 40%, from 5 to 35%, from 5 to 30%, from 5 to 25%, from 5 to 20%, from 10 to 40%, from 10 to 35%, from 10 to 30%, from 10 to 25%, from 10 to 20%, from 15 to 40%, from 15 to 35%, from 15 to 30%, from 20 to 40%, and from 20 to 35%, all based on the weight of the woven fabric. The secondary yarn maybe selected from any suitable synthetic yarn with a melting point that is lower than the melting point of the base yarn. Suitable secondary yarns include synthetic yarns with a linear mass density in the range of 20 to 800 decitex and a melting point in the range of 60 to 160 degrees Celsius. In certain embodiments, the secondary yarns may have, for example, a linear mass density ranging from 100 to 700 decitex, from 150 to 500 decitex, from 200 to 600 decitex, from 250 to 550 decitex, from 300 to 550 decitex, and from 300 to 500 decitex. In other embodiments, the secondary yarns may have, for example, a melting point ranging from 80 to 160 degrees Celsius, from 90 to 160 degrees Celsius, from 100 to 160 degrees Celsius, from 110 to 160 degrees Celsius, from 120 to 160 degrees Celsius, from 60 to 155 degrees Celsius, from 80 to 155 degrees Celsius, from 90 to 155 degrees Celsius, from 100 to 155 degrees Celsius, from 110 to 155 degrees Celsius, from 120 to 155 degrees Celsius, from 80 to 150 degrees Celsius, from 90 to 150 degrees Celsius, from 100 to 150 degrees Celsius, from 110 to 150 degrees Celsius, and from 120 to 150 degrees Celsius. Examples of suitable synthetic yarns are formed from polyolefins and co-polyamide monofilament sewing yarns. Suitable polyolefins yarns include, but are not limited to those formed from polyethylene or high density polyethylene (HDPE) fibers. In one nonlimiting embodiment of the present invention, the base yarn is formed from a HDPE fiber.

The secondary yarn may also be comprised of fibers and filaments of different materials. If a secondary yarn is used that contains more than one fiber or filament type, then only one of those fibers or filament types will need to have a melting point that lower than the melting point of the base yarn. In one nonlimiting embodiment, the secondary yarn may contain a mixture of polyamide and polyolefin fibers and filaments.

The fiber used to form the base yarn and secondary yarn may also comprise various additives used in the production and processing of fibers. Suitable additives include, but are not limited to a thermal stabilizer, antioxidant, photo stabilizer, smoothing agent, antistatic agent, plasticizer, thickening agent, pigment, flame retarder or combinations thereof.

The woven fabric of the present invention may be formed from warp and weft yarns using weaving techniques known in the art. Suitable weaving techniques include, but are not limited to a plain weave, twill weave, satin weave, modified weaves of these types or a multi-axial weave. Suitable looms that can be used for weaving include a water jet loom, air jet loom or rapier loom. Suitable woven fabrics of the present invention have a total base weight in the range of 80 to 450 grams per square meter. In certain embodiments, the total base weight of the woven fabric can range from 100 to 450 grams per square meter, from 100 to 400 grams per square meter, from 100 to 350 grams per square meter, from 150 to 450 grams per square meter, from 150 to 400 grams per square meter, from 150 to 350 grams per square meter, from 200 to 450 grams per square meter, from 200 to 400 grams per square meter, from to 200 to 350 grams per square meter, from 250 to 450 grams per square meter, from to 250 to 400 grams per square meter, and from 250 to 350 grams per square meter.

Table 1 summarizes suitable embodiments of the present invention.

TABLE 1

| | | | | | Base | | Secondary |
|---|---|---|---|---|---|---|---|
| | | Greige | Finished | | Weight | | yarn |
| TRIAL | | Yarns/cm | Yarns/cm | Dtex | g/m² | Pick Ratio | % of Wt |
| Control | Warp (base | 15.33 | 16.10 | 700 | 127.0 | | |
| | yarn) | | | | | | |
| | Weft 1(base | 20.00 | 21.00 | 700 | 165.7 | 1 | |
| | yarn) | | | | | | |
| | Weft 2 | — | — | 470 | 0.0 | | 0.0% |
| | (Secondary | | | | | | |
| | yarn) | | | | | | |
| | Total weight | | | | 292.7 | | |
| | g/m² | | | | | | |
| 1 | Warp (base | 15.33 | 16.10 | 700 | 127.0 | | |
| | yarn) | | | | | | |
| | Weft 1(base | 10.00 | 10.50 | 700 | 82.8 | 1 | |
| | yarn) | | | | | | |
| | Weft 2 | 10.00 | 10.50 | 700 | 82.8 | 1 | 28.3% |
| | (Secondary | | | | | | |
| | yarn) | | | | | | |
| | Total weight | | | | 292.7 | | |
| | g/m² | | | | | | |
| 2 | Warp (base | 15.33 | 16.10 | 700 | 127.0 | | |
| | yarn) | | | | | | |
| | Weft 1(base | 15.00 | 15.75 | 700 | 124.2 | 3 | |
| | yarn) | | | | | | |
| | Weft 2 | 5.00 | 5.25 | 700 | 41.4 | 1 | 14.2% |
| | (Secondary | | | | | | |
| | yarn) | | | | | | |
| | Total weight | | | | 292.7 | | |
| | g/m² | | | | | | |
| 3 | Warp (base | 15.33 | 16.10 | 700 | 127.0 | | |
| | yarn) | | | | | | |
| | Weft 1(base | 10.95 | 11.50 | 700 | 90.7 | 1 | |
| | yarn) | | | | | | |
| | Weft 2 | 10.95 | 11.50 | 700 | 90.7 | 1 | 29.4% |
| | (Secondary | | | | | | |
| | yarn) | | | | | | |
| | Total weight | | | | 308.4 | | |
| | g/m² | | | | | | |
| 4 | Warp (base | 15.33 | 16.10 | 700 | 127.0 | | |
| | yarn) | | | | | | |
| | Weft 1(base | 12.14 | 12.75 | 700 | 100.6 | 1 | |
| | yarn) | | | | | | |
| | Weft 2 | 12.14 | 12.75 | 470 | 67.5 | 1 | 22.9% |
| | (Secondary | | | | | | |
| | yarn) | | | | | | |
| | Total weight | | | | 295.1 | | |
| | g/m² | | | | | | |
| 5 | Warp (base | 15.33 | 16.10 | 700 | 127.0 | | |
| | yarn) | | | | | | |
| | Weft 1(base | 13.81 | 14.50 | 700 | 114.4 | 1 | |
| | yarn) | | | | | | |
| | Weft 2 | 13.81 | 14.50 | 470 | 76.8 | 1 | 24.1% |
| | (Secondary | | | | | | |
| | yarn) | | | | | | |
| | Total weight | | | | 318.2 | | |
| | g/m² | | | | | | |
| 6 | Warp (base | 15.33 | 16.10 | 700 | 127.0 | | |
| | yarn) | | | | | | |
| | Weft 1(base | 14.76 | 15.50 | 470 | 82.1 | 1 | |
| | yarn) | | | | | | |
| | Weft 2 | 14.76 | 15.50 | 470 | 82.1 | 1 | 28.2% |
| | (Secondary | | | | | | |
| | yarn) | | | | | | |
| | Total weight | | | | 291.2 | | |
| | g/m² | | | | | | |
| 7 | Warp (base | 15.33 | 16.10 | 700 | 127.0 | | |
| | yarn) | | | | | | |
| | Weft 1(base | 22.14 | 23.25 | 470 | 123.1 | 3 | |
| | yarn) | | | | | | |
| | Weft 2 | 7.38 | 7.75 | 470 | 41.0 | 1 | 14.1% |
| | (Secondary | | | | | | |
| | yarn) | | | | | | |
| | Total weight | | | | 291.2 | | |
| | g/m² | | | | | | |
| 8 | Warp (base | 15.33 | 16.10 | 700 | 127.0 | | |
| | yarn) | | | | | | |
| | Weft 1(base | 10.95 | 11.50 | 700 | 90.7 | 1 | |
| | yarn) | | | | | | |
| | Weft 2 | 10.95 | 11.50 | 350 | 45.4 | 1 | 17.2% |
| | (Secondary | | | | | | |
| | yarn) | | | | | | |
| | Total weight | | | | 263.1 | | |
| | g/m² | | | | | | |

In one embodiment of the present invention, the secondary yarn is interwoven into the base yarn, wherein and at least a portion of the secondary yarn has been melted such that interstices between the base yarn are bridged by the melted portion of the secondary yarn. Without being bound any specific theory, it is believed that the melted portion of the secondary yarn fills the interstices in the woven fabric to reduce the air permeability and porosity of the woven fabric.

In one embodiment of the present invention, the woven fabric has an air permeability that is at least 50% lower than the air permeability of a woven fabric formed from only the base yarn at the same fabric construction. In another embodiment of the present invention, the woven fabric has an air permeability that is at least 75% lower than the air permeability of a woven fabric formed from only the base yarn at the same fabric construction. In further embodiments, the woven fabric has an air permeability that is lower than the air permeability of a woven fabric formed from only the base yarn at the same fabric construction by the following amounts: at least 80%, at least 85%, at least 90%, and at least 95%.

In one embodiment of the present invention, the woven fabric has a porosity that is at least 50% lower than the porosity of a woven fabric formed from only the base yarn at the same fabric construction. In another embodiment of the present invention, the woven fabric has a porosity that is at least 75% lower than the porosity of a woven fabric formed from only the base yarn at the same fabric construction. In further embodiments, the woven fabric has a porosity that is lower than the porosity of a woven fabric formed from only the base yarn at the same fabric construction by the following amounts: at least 80%, at least 85%, at least 90%, and at least 95%.

In one embodiment of the present invention, the woven fabric has an air permeability that is at least 50% lower than the air permeability of the woven fabric prior to at least a portion of the secondary yarn being melted such that interstices between the base yarn are bridged by the melted portion of the secondary yarn.

In one embodiment of the present invention, the woven fabric has an air permeability that is at least 75% lower than the air permeability of the woven fabric prior to at least a portion of the secondary yarn being melted such that interstices between the base yarn are bridged by the melted portion of the secondary yarn. In further embodiments, the woven fabric has an air permeability that is lower than the air permeability of the woven fabric prior to at least a portion of the secondary yarn being melted such that interstices between the base yarn are bridged by the melted portion of the secondary yarn by the following amounts: at least 80%, at least 85%, at least 90%, and at least 95%.

In one embodiment of the present invention, the woven fabric has a porosity that is at least 50% lower than the porosity of a woven fabric prior to at least a portion of the secondary yarn being melted such that interstices between the base yarn are bridged by the melted portion of the secondary yarn. In another embodiment of the present invention, the woven fabric has a porosity that is at least 75% lower than the porosity of a woven fabric prior to at least a portion of the secondary yarn being melted such that interstices between the base yarn are bridged by the melted portion of the secondary yarn. In further embodiments, the woven fabric has a porosity that is lower than the porosity of a woven fabric prior to at least a portion of the secondary yarn being melted such that interstices between the base yarn are bridged by the melted portion of the secondary yarn by the following amounts: at least 80%, at least 85%, at least 90%, and at least 95%.

In another aspect of the present invention, a fused fabric is disclosed comprising a woven fabric comprising a base yarn, wherein the base yarn contains interstices; and a filling material which at least partially fills the interstices in the base yarn.

In these embodiments, and as described above, the base yarn may be present in a range resulting in 60 to 99.9% by weight of the fused fabric. As described above, the base yarn may be selected from any suitable synthetic yarn. Examples of suitable synthetic yarns that may be used for the base yarn include yarns formed from polyamide or polyester fibers.

Suitable polyamide fibers have a linear mass density in the range from 100 to 950 decitex. Suitable polyamide fibers include those formed from nylon 6,6, nylon 6, nylon 6,12, nylon 12, nylon 4,6 or copolymers or blends thereof. In one nonlimiting embodiment of the present invention, the base yarn is formed from a nylon 6,6 fiber.

Suitable polyester fibers have a linear mass density in the range of 200 to 950 decitex. Suitable polyester fibers include those formed from polyethylene terephthalate (PET), polybutylene terephthalate, polyethylene naphthalate, polybutylene naphthalate, polyethylene-1,2-bis(phenoxy)ethane-4,4′-dicarboxylate, poly(1,4cyclohexylene-dimethylene terephthalate and copolymers comprising at least one type of recurring units of the above-mentioned polymers, for example, polyethylene terephthalate/isophthalate copolyesters, polybutylene terephthalate/naphthalate copolyesters, polybutylene terephthalate/decanedicarboxylate copolyesters, or copolymers or blends thereof. In one nonlimiting embodiment of the present invention, the base yarn is formed from a PET fiber.

The fused fabric of the present invention further comprises a filling material that may be present in a range resulting in 0.1 to 40% by weight of the treated fabric. In certain embodiments, the filling material may be present, for example, in an amount ranging from 0.1 to 35%, from 0.1 to 30%, from 0.1 to 25%, from 0.1 to 20%, from 0.5 to 40%, from 0.5 to 35%, from 0.5 to 30%, from 0.5 to 25%, from 0.5 to 20%, from 1 to 40%, from 1 to 35%, from 1 to 30%, from 1 to 25%, from 1 to 20%, from 5 to 40%, from 5 to 35%, from 5 to 30%, from 5 to 25%, from 5 to 20%, from 10 to 40%, from 10 to 35%, from 10 to 30%, from 10 to 25%, from 10 to 20%, from 15 to 40%, from 15 to 35%, from 15 to 30%, from 20 to 40%, and from 20 to 35%, all based on the weight of the fused fabric. The filling material maybe selected from any suitable synthetic polymer with a melting point that is lower than the melting point of the base yarn. Examples of suitable synthetic polymers are polyolefins, such as those described above. Suitable polyolefins include, but are not limited to those formed from polyethylene or high density polyethylene (HDPE) fibers. In one nonlimiting embodiment of the present invention, the filling material is HDPE.

Also provided in the present invention are airbags formed from the woven fabrics and fused fabrics disclosed herein. The term airbags, as used herein, includes airbag cushions. Airbag cushions are typically formed multiple panels of fabrics and can be rapidly inflated.

Also provided in the present invention are processes for making a treated fabric. The treated fabrics from these processes may be used in the production of airbags. Woven fabrics that can be used in many industrial applications, such as airbags, require fabrics that meet mechanical and performance standards while limiting overall fabric weight and cost.

In these processes, a base yarn is interwoven with a secondary yarn to form a woven fabric, wherein the secondary yarn has a melting point that is lower than the melting point of base yarn. Various methods and apparatuses for weaving yarns are known and can be used for production of fabrics of the instant invention. Suitable weaving techniques include, but are not limited to a plain weave, twill weave, satin weave, modified weaves of these types or a multi-axial weave. Suitable looms include, but are not limited to a water jet loom, air jet loom or rapier loom. As described above, suitable woven fabrics of the present invention have a base weight in the range of 80 to 450 grams per square meter.

In one embodiment, the woven fabric is heated to a temperature above the melting point of the secondary yarn and below the melting point of the base yarn, wherein at least a portion of the secondary yarn melts to form a treated fabric. Various methods for melting a portion of the secondary yarn may be used. In one nonlimiting embodiment, the woven fabric is calendered to melt or soften the secondary yarn so that the interstices of the woven fabric are filled with the melted or softened secondary yarn.

As will be understood by the skilled artisan upon reading this disclosure, alternative methods and apparatus to those exemplified herein which result in melting at least a portion of the secondary yarn are available and use thereof is encompassed by the present invention.

The base yarn may be present in a range resulting in 60 to 99.9% by weight of the woven fabric, as described above. The base yarn may be selected from any suitable synthetic yarn. Examples of suitable synthetic yarns that may be used for the base yarn include yarns formed from polyamide or polyester fibers.

As described above, suitable polyamide fibers have a linear mass density in the range from 100 to 950 decitex. Suitable polyamide fibers include those formed from nylon 6,6, nylon 6, nylon 6,12, nylon 12, nylon 4,6 or copolymers or blends thereof. In one embodiment of the present invention, the base yarn is formed from a nylon 6,6 fiber.

Suitable polyester fibers have a linear mass density in the range of 200 to 950 decitex. Suitable polyester fibers include those formed from polyethylene terephthalate (PET), polybutylene terephthalate, polyethylene naphthalate, polybutylene naphthalate, polyethylene-1,2-bis(phenoxy)ethane-4,4′-dicarboxylate, poly(1,4cyclohexylene-dimethylene terephthalate and copolymers comprising at least one type of recurring units of the above-mentioned polymers, for example, polyethylene terephthalate/isophthalate copolyesters, polybutylene terephthalate/naphthalate copolyesters, polybutylene terephthalate/decanedicarboxylate copolyesters, or copolymers or blends thereof. In one embodiment of the present invention, the base yarn is formed from a PET fiber.

The woven fabric of this process further comprises a secondary yarn that, as described above, may be present in a range resulting in 0.1 to 40% by weight of the woven fabric. The secondary yarn maybe selected from any suitable synthetic yarn with a melting point that is lower than the melting point of the base yarn. Suitable secondary yarns include synthetic yarns with a linear mass density in the range of 20 to 800 decitex and a melting point in the range of 60 to 160 degrees Celsius. Examples of suitable synthetic yarns are formed from polyolefins and co-polyamide monofilament sewing yarns. Suitable polyolefins yarns include, but are not limited to those formed from polyethylene or high density polyethylene (HDPE) fibers. In one embodiment for producing an airbag of the present invention, the base yarn is formed from a HDPE fiber.

The secondary yarn may also be comprised of fibers and filaments of different materials. If a secondary yarn is used that contains more than one fiber or filament type, then only one of those fibers or filament types will need to have a melting point that lower than the melting point of the base yarn. In one nonlimiting embodiment, the secondary yarn may contain a mixture of polyamide and polyolefin fibers and filaments.

The fiber used to form the base yarn and secondary yarn may also comprise various additives used in the production and processing of fibers. Suitable additives include, but are not limited to a thermal stabilizer, antioxidant, photo stabilizer, smoothing agent, antistatic agent, plasticizer, thickening agent, pigment, flame retarder or combinations thereof.

It is desirable for the treated fabrics of the processes of the present invention to have significantly lower air permeability and/or porosity than woven fabrics formed only from the base yarn. This will allow the treated fabrics disclosed herein to be used in industrial applications, such as airbags, without the need of a coating, a film or non-woven fabric being applied. In one embodiment of the process, the treated fabric has an air permeability that is at least 50% lower than the air permeability of a woven fabric formed from only the base yarn at the same fabric construction. As described above, further embodiments contemplate a treated fabric having an air permeability that is lower than the air permeability of a woven fabric formed from only the base yarn at the same fabric construction by the following amounts: at least 75%, at least 80%, at least 85%, at least 90%, and at least 95%. In another embodiment of the present invention, the treated fabric has a porosity that is at least 50% lower than the porosity of a woven fabric formed from only the base yarn at the same fabric construction. As described above, further embodiments contemplate a woven fabric or treated fabric having a porosity that is lower than the porosity of a woven fabric formed from only the base yarn at the same fabric construction by the following amounts: at least 75%, at least 80%, at least 85%, at least 90%, and at least 95%.

In one embodiment of the process of the present invention, the treated fabric has an air permeability that is at least 50% lower than the air permeability of the woven fabric prior to at least a portion of the secondary yarn being melted such that interstices between the base yarn are bridged by the melted portion of the secondary yarn. Again, as described above, further embodiments contemplate a treated fabric having an air permeability that is lower than the air permeability of the woven fabric prior to at least a portion of the secondary yarn being melted such that interstices between the base yarn are bridged by the melted portion of the secondary yarn by the following amounts: at least 75%, at least 80%, at least 85%, at least 90%, and at least 95%.

In yet another embodiment of the process of present invention, the treated fabric has porosity that is at least 50% lower than the porosity of the woven fabric prior to at least a portion of the secondary yarn being melted such that interstices between the base yarn are bridged by the melted portion of the secondary yarn. Yet again, as described above, further embodiments contemplate a treated fabric having porosity that is lower than the porosity of the woven fabric prior to at least a portion of the secondary yarn being melted such that interstices between the base yarn are bridged by the melted portion, of the secondary yarn by the following amounts: at least 75%, at least 80%, at least 85%, at least 90%, and at least 95%.

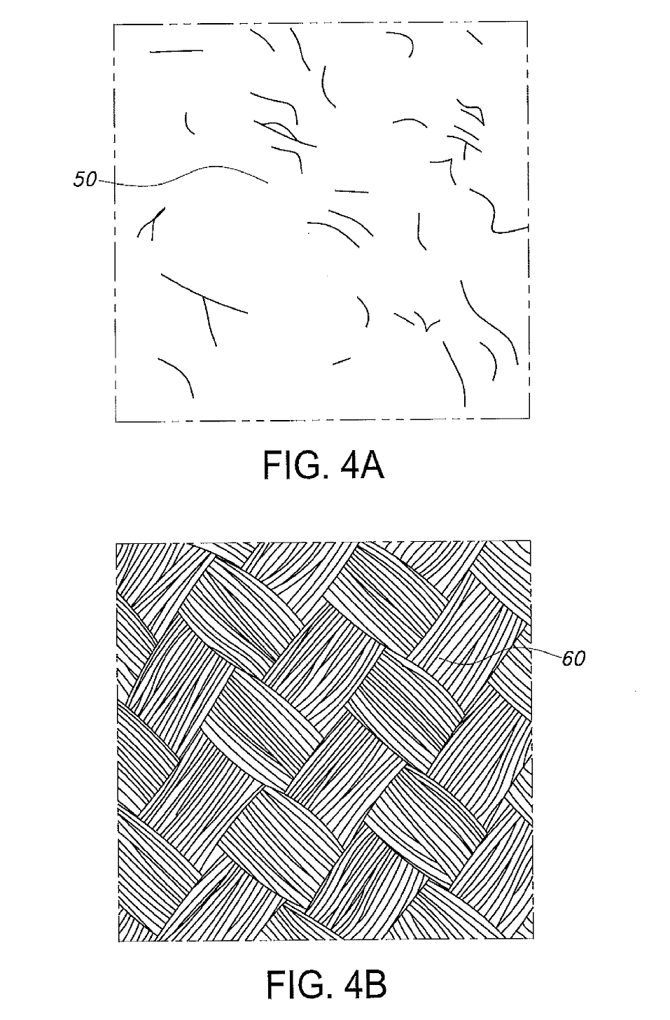

The weave design and construction dictates where the secondary yarn will result in the fabric structure after calendaring. For example, a plain weave would result in even distribution of secondary yarn throughout the structure of the fabric. One may choose the weave design as needed per end-use application of the fabric. FIG. 4 shows a fabric formed a weave design wherein the secondary yarn is primarily found on one side of the fabric. As can be seen in FIG. 4A, the secondary yarn forms a layer 50 on one side of the fabric after calendaring. As can be seen in FIG. 4B, the primary yarn remains in woven form 60 on the other side of the fabric. The mechanical properties of the fabric are primarily dictated by the base yarn, which in nonlimiting embodiments can be nylon 6,6. The secondary yarn, which in nonlimiting embodiments may be polyethylene, contributes primarily via closing of the inter-yarn interstices as well as via contributing to the thermal resistance of the fabric. Additives may also be used with melt-component to further enhance the thermal resistance of the fabric structure.

### EXAMPLES

The following Examples demonstrate the present invention and its capability for use. The invention is capable of other and different embodiments, and its several details are capable of modifications in various apparent respects, without departing from the scope and spirit of the present invention. Accordingly, the Examples are to be regarded as illustrative in nature and non-limiting.

### Test Methods

Fabric thermal resistance determination: The resistance of fabrics to compromise by penetration of hot particulates was determined according to the testing methodology, described Barnes and Rawson [Barnes, J. A., and Rawson, N. J. Proc. 8th World Textile Congress, Industrial, Technical and High Performance Textiles, University of Huddersfield, Jul. 15-16, 1998, pp 329-338]. Briefly, a series of steel penetrators having masses from 0.9 to 44 g are used to apply thermal load to a fabric sample. The net time required for each heated penetrator to melt through the fabric is recorded, and a conversion to incident energy is calculated according to Equation 1:

E=mpΔT (Equation 1)

Where E=energy (J), m=mass (kg), p=specific heat capacity [J/(kg*K)], and ΔT (K) is the difference between the initial temperature of the penetrator, and ambient temperature. A plot of time-to-melt vs. incident energy is then constructed to give a reliable determination of comparative performance of fabric samples.

Air permeability of textile fabrics: The air permeability of fabrics was determined according to ASTM D737.

### Example 1:

A plain weave fabric made from Nylon 6,6 base yarn was sewn with high density polyethylene (HDPE) secondary yarn to form a woven fabric. The woven fabric was heated to a temperature of 135 degrees Celsius. It was observed that a portion of the HDPE secondary yarn melted and filled the interstices of the woven fabric.

### Example 2

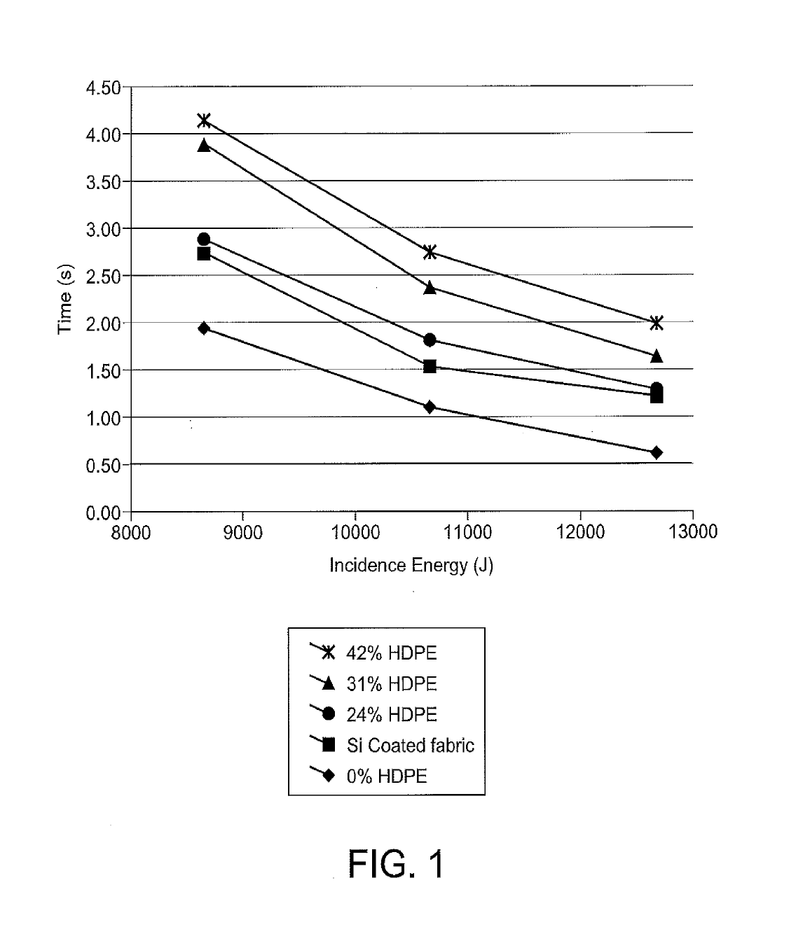

Fabrics from the first trial were also tested for the thermal resistance of the fabrics. Typical airbag fabric were coated with silicone-based elastomers to increase the thermal resistance of the base fabric. As shown in the chart depicted in FIG. 1, increasing the amount of HDPE in the fabric resulted in higher thermal resistance of the fabric.

In the second trial, multi-filament PE yarns were utilized for fabric constructions that were subsequently melted via calendaring to reduce the air-permeability of the fabric.

| | | | | | | After- |
|---|---|---|---|---|---|---|
| | | | | Fabric | | Calendering |
| | | | PE | Basis | Initial Static Air | Static Air |
| TRIAL 2 | | | content | weight | Permeability | Permeability |
| Codes | Yarns | Yarns/cm | (%) | (gsm) | (L/dm²/min) | (L/dm²/min) |
| Control_2 | Warp | 21.5 | | 263 | 25.0 | N/A |
| | (Nylon | | | | | |
| | 6,6), 470 | | | | | |
| | dTex | | | | | |
| | Weft 1 | 27.8 | | | | |
| | (Nylon | | | | | |
| | 6,6), 470 | | | | | |
| | dTex | | | | | |
| | Weft 2 | — | | | | |
| 9 | Warp | 21.5 | | 256 | 29.2 | 6.4 |
| | (Nylon | | | | | |
| | 6,6), 470 | | | | | |
| | dTex | | | | | |
| | Weft 1 | 13.5 | | | | |
| | (Nylon | | | | | |
| | 6,6), 470 | | | | | |
| | dTex | | | | | |
| | Weft 2 | 13.5 | 30 | | | |
| | (HDPE) | | | | | |
| | 520 dTex | | | | | |
| 10 | Warp | 21.5 | | 260 | 104.7 | 2.1 |
| | (Nylon | | | | | |
| | 6,6), 470 | | | | | |
| | dTex | | | | | |
| | Weft 1 | 11.5 | | | | |
| | (Nylon | | | | | |
| | 6,6), 470 | | | | | |
| | dTex | | | | | |
| | Weft 2 | 11.5 | 33 | | | |
| | (LDPE) | | | | | |
| | 2X333 | | | | | |
| | dTex | | | | | |
| 11 | Warp | 17.5 | | 227 | 74.0 | 1.1 |
| | (Nylon | | | | | |
| | 6,6), 470 | | | | | |
| | dTex | | | | | |
| | Weft 1 | 11 | | | | |
| | (Nylon | | | | | |
| | 6,6), 470 | | | | | |
| | dTex | | | | | |
| | Weft 2 | 11 | 35 | | | |
| | (LDPE) | | | | | |
| | 2X333 | | | | | |
| | dTex | | | | | |

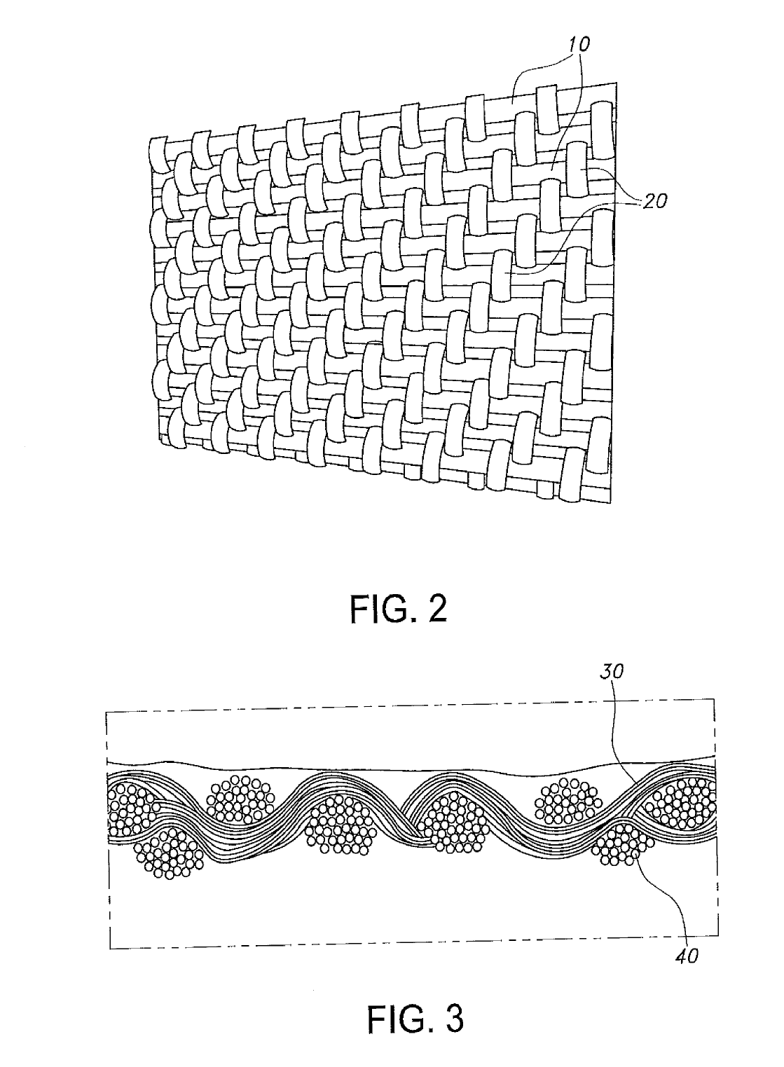

The fabric design was illustrated in FIG. 2, in which the black yarn 10 represents PE and the white yarn 20 represents the Nylon 6,6 described in all construction in above table. When this structure was calendared at a temperature to just above the melting point of the PE yarn, it resulted in a closed porosity structure show via the SEM cross-section depicted in FIG. 3, wherein the Nylon 6,6 yarn 40 can be seen in its original form and PE yarn 30 is shown as melted and filling in the interstices in the nylon 6,6 yarn.

This fabric construction used enabled the PE component 50 to be kept primarily on one side of the fabric as seen in the photo micrograph depicted in FIG. 4A. FIG. 4B shows the nylon 6,6 yarn 60 still in woven form on the other side of the fabric. In another nonlimiting embodiment, a fabric constructions may used wherein the secondary yarn is woven such that is it imbedded within the base yarn.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt% to about 5 wt%, but also the individual concentrations (e.g., 1%, 2%, 3%, and 4%) and the sub-ranges (e.g., 0.5%, 1.1%, 2.2%, 33%, and 4.4%) within the indicated range. The term “about” can include ±1%, ±2%, ±3%, ±4%, ±5%, ±8%, or ±10%, of the numerical value(s) being modified. In addition, the phrase “about ‘x’ to ‘y’” includes “about ‘x’ to about ‘y’”. While the illustrative embodiments of the invention have been described with particularity, it will be understood that the invention is capable of other and different embodiments and that various other modifications will be apparent to and may be readily made by those skilled in the art without departing from the spirit and scope of the invention. Accordingly, it is not intended that the scope of the claims hereof be limited to the examples and descriptions set forth herein but rather that the claims be construed as encompassing all the features of patentable novelty which reside in the present disclosure, including all features which would be treated as equivalents thereof by those skilled in the art to which the invention pertains.

1. A woven fabric comprising:
a) a base yarn; and
b) a secondary yarn, wherein the secondary yarn is interwoven into the base yarn, and wherein the secondary yarn has a melting point that is lower than the melting point of base yarn.

2. The woven fabric of claim 1 wherein the woven fabric contains interstices and at least a portion of the secondary yarn has been melted such that the interstices between the base yarn are bridged by the melted portion of the secondary yarn.

3. The woven fabric of claim 1 wherein the fabric has a base weight in the range from 80 to 450 grams per square meter.

4. The woven fabric of claim 1 wherein the secondary yarn is present in the fabric in a range from 10 to 40 weight percent.

5. The woven fabric of claim 1 wherein the base yarn is formed from a polyamide fiber.

6. The woven fabric of claim 1 wherein the base yarn is formed from a nylon 6,6 fiber.

7. The woven fabric of claim 1 wherein the base yarn formed from a polyester fiber.

8. The woven fabric of claim 1 wherein the base yarn is formed from a polyethylene terephthalate fiber.

9. The woven fabric of claim 1 wherein the secondary yarn has a linear mass density in the range from 20 to 800 decitex.

10. The woven fabric of claim 1 wherein the secondary yarn is formed from a polyolefin fiber.

11. The woven fabric of claim 1 wherein the secondary yarn is formed from a high density polyethylene fiber.

12. The woven fabric of claim 2, wherein the woven fabric has an air permeability that is at least 50% lower than the air permeability of the woven fabric prior to at least a portion of the secondary yarn being melted such that interstices between the base yarn are bridged by the melted portion of the secondary yarn.

13. The woven fabric of claim 2, wherein the woven fabric has an air permeability that is at least 75% lower than the air permeability of the woven fabric prior to at least a portion of the secondary yarn being melted such that interstices between the base yarn are bridged by the melted portion of the secondary yarn.

14. An airbag comprising the woven fabric of claim 1.

15. A fused fabric comprising:
a) a woven fabric comprising a base yarn, wherein the base yarn contains interstices; and
b) a filling material which at least partially fills the interstices in the base yarn.

16. The fused fabric of claim 15 wherein the filling material is present in a range from 10 to 40 weight percent of the fused fabric.

17. The fused fabric of claim 15 wherein the base yarn is formed from a polyamide fiber.

18. The fused fabric of claim 15 wherein the base yarn is formed from a nylon 6,6 fiber.

19. The fused fabric of claim 15 wherein the base yarn formed from a polyester fiber.

20. The fused fabric of claim 15 wherein the base yarn is formed from a polyethylene terephthalate fiber.

21. The fused fabric of claim 15 wherein the filling material is formed from a polyolefin.

22. The fused fabric of claim 15 wherein the filling material is formed from high density polyethylene.

23. An airbag comprising the fused fabric of claim 15.

24. A process for making a treated fabric comprising the steps of:
a) interweaving a base yarn with a secondary yarn to form a woven fabric, wherein the secondary yarn has a melting point that is lower than the melting point of the base yarn; and
b) heating the woven fabric to a temperature above the melting point of the secondary yarn and below the melting point of the base yarn, wherein at least a portion of the secondary yarn melts to form a treated fabric.

25. The process of claim 24 wherein at least a portion of the secondary yarn is melted such that interstices between the base yarn are bridged by the melted portion of secondary yarn.

26. The process of claim 24, wherein the treated fabric has an air permeability that is at least 50% lower than the air permeability of the woven fabric formed in step (a).

27. The process of claim 24, wherein the treated fabric has an air permeability that is at least 75% lower than the air permeability of the woven fabric formed in step (a).

28. The process of claim 24 wherein the woven fabric has a base weight in the range from 80 to 450 grams per square meter.

29. The process of claim 24 wherein the secondary yarn is present in the woven fabric in a range from 1 to 40 weight percent.

30. The process of claim 24 wherein the base yarn is formed from a polyamide fiber.

31. The process of claim 24 wherein the base yarn is formed from a nylon 6,6 fiber.

32. The process of claim 24 wherein the base yarn formed from a polyester fiber.

33. The process of claim 24 wherein the base yarn is formed from a polyethylene terephthalate fiber.

34. The process of claim 24 wherein the secondary yarn has a linear mass density in the range from 20 to 800 decitex.

35. The process of claim 24 wherein the secondary yarn is formed from a polyolefin fiber.

36. The process of claim 24 wherein the secondary yarn is formed from a polyethylene fiber.

37. The process of claim 24 wherein the secondary yarn is formed from a high density polyethylene fiber.

38. A treated fabric formed from the process of claim 24.

39. An airbag formed from the treated fabric of claim 38.
